(19) United States
(12) Patent Application Publication
(10) Pub. No.: US 2003/0071735 A1
(43) Pub. Date: Apr. 17, 2003

(54) Wildlife warning system

(76) Inventors: Randy Hanson, Saskatoon (CA); Terry Bergan, Grasswood (CA)

Correspondence Address: NIXON & VANDERHYE P.C., 8th Floor, 1100 North Glebe Rd., Arlington, VA, 22201-4714, US

(21) Appl. No.: 10/061,182

(22) Filed: Feb. 4, 2002

(30) Foreign Application Priority Data
Oct. 12, 2001 (CA) 2,358,728

(51) Int. Cl. G08B 23/00

(52) U.S. Cl. 340/573.2; 340/384.2; 340/933

(57) ABSTRACT

A novel wildlife warning system is provided herein. The system includes one or more vehicle sensors adjacent a roadway to sense an approaching vehicle, and to provide a sensor signal upon sensing the approach. One or more warning alarms which are remote from the roadway are configured to generate a wildlife warning signal. One or more transmitters are remotely connected to the vehicle sensor or sensors for transmitting an actuating signal to the warning alarm or alarms upon reception of the sensed signal, thereby to send a warning to the wildlife. The warning alarms may be chain triggered, or may be controlled by a master controller in a pre-programmed manner.

### BACKGROUND OF THE INVENTION

(a) Field of the Invention

This invention relates to wildlife warning systems for highway and other traffic areas.

(b) Description of the Prior Art

Wildlife, e.g., deer and moose, crossing highways pose a serious accident risk, and result in damages to vehicles, and loss of lives.

Every year accidents are caused by large wildlife attempting to cross roads and highways. The resulting vehicle and property damage runs into the millions of dollars, not to mention the loss of lives, on which no price can be placed.

It is not uncommon for cars and trucks to strike animals as they proceed along highways or other roads. Dogs and sometimes raccoons and other similar animals often chase moving vehicles and are frequently killed by colliding with the vehicle. In more heavily forested areas, larger animals such as deer and even moose, are even sometimes found on highways. Collisions with those animals are, of course, fatal to the animal and possibly also to humans, and very damaging to the vehicle. This is, therefore, a serious problem for vehicle operators.

It is commonly known that there is increasing damage and loss caused by the rising deer population foraging in search of food. Thus, deer who are foraging for food, wander onto private properties to eat landscaping material and such damage done by foraging deer to agriculture and forestry sections is extensive, according to reports issued by the U.S. Department of Interior Fish and Wildlife Services.

Moreover, there is a substantial hazard connected with vehicle collisions with deer due to deer crossing roads and highways, and escalating repair costs for vehicle damage as well as medical costs associated with such collisions are increasing all the time.

Accidents involving cars or trucks striking deer or other large animals, result in millions of dollars of property damage and often times bodily injury each year. With increasing deer populations, these accidents are becoming more frequent. These accidents are most common in October, November and early December, when the deer are in rut, and in April, May, June for foaling. According to Iowa DOT statistics, the number of deer-related accidents in Iowa in 1996 was over 12,000, up approximately 3% from 1995.

In 1965, 48 states reported the adjusted national total of deer killed was 121,750, with a tabulated figure of human fatalities as 115 people killed, 1500 injured according to the National Safety Council. In 1965, the state of Illinois reported actual deer killed as 1,004. In 1995, the state of Illinois reported an actual vehicle-deer accident toll of 17,573. In 1995, all states reported 251 people killed, 3,010 injured, with 325,000 deer killed.

Many devices have been tried in the past in an effort to scare or deter the deer away from roads, so as to reduce the number of such accidents. For example, whistles and reflectors have been used to scare the deer away. However, deer quickly adapt to such deterrent devices, which soon loose effectiveness. Fences have also been used, but only deter the deer to another road crossing location.

Many types of devices and methods have been and are presently being used to discourage animals, e.g., deer, from causing damage to landscaping material, e.g., perimeter fencing, which may or may not be electrified, as well as the covering of shrubs with some type of netting. These arrangements are time consuming and impair the aesthetics of the property to be protected. Furthermore, audio frequency emission systems for repelling deer presently in use are difficult to install and generally operate continuously thereby allowing deer to become accustomed to the constant audio output and thereby making the devices ineffective.

Property owners must deal with the possibility of intrusion upon their property by animals. While an animal simply travelling across the property may not be a problem, it can create a nuisance when the intruding animal chooses to dig holes, mark its territory, or dig in trash cans, etc. One possible method of preventing animal intrusion was by erecting a fence or other barrier; however, this is often expensive and may not be aesthetically pleasing or practicable. For example, a property owner may wish to keep animals away from an ornamental garden. Raising a fence is impractical as it obscured the garden and ruined the ornamental effect. Furthermore, the property owner may not need the entire property protected. For example, a property owner may simply need to keep animals out of a trash can.

Another possible method of preventing animal intrusion is through the use of traps or poisons. However, in a residential community where an offending animal is potentially another property owner's pet, this method was unacceptable.

Various animal deterrent systems are presently available. The deterrent stimuli used in presently available animal deterrent systems were typically audible, with the primary difference being the frequency range of the deterrent. Animal deterrent systems having deterrents which were audible in the range of human hearing quickly became a nuisance for the property owner and neighbours alike. These deterrents must be loud enough to startle and frighten the animal sufficiently to be effective as a deterrent. Further, because animal deterrent systems were desired for night time protection, the deterrent may be activated during the night. This was unacceptable in many residential neighbourhoods where houses are in close proximity.

More common were ultrasonic deterrents which operate at frequencies above the range of human hearing. Typically, animal deterrent systems incorporating an ultrasonic deterrent utilized a single frequency deterrent. While the selected frequency was chosen to have a deterrent effect, the constant frequency can fail to get the attention of the animal. Furthermore, the use of a single frequency did not contemplate variations in the hearing capabilities of the animals, potentially limiting the effectiveness of the animal deterrent system.

Presently available animal deterrent systems may alternatively incorporate an infrared sensor for detecting the presence of an animal having a body temperature warmer than that of the ambient atmosphere. Typically, these sensors simply reacted to the presence of such a body. Accordingly, should an animal enter into the range of the sensor, the deterrent will continuously sound while the animal remained within the sensor range. Because a single deterrent pulse has the required deterrent effect, the use of a continuous deterrent places an unnecessary drain on the power supply.

Properly mounting the animal deterrent system in isolated, outdoor locations was crucial for maintaining protection of the desired area. One method for mounting presently available animal deterrent systems in an isolated outdoor location was a stake which can be driven into the ground, for example in a garden. The stake was typically a rounded peg which supports the sensor unit. However, animal deterrent systems incorporating a rounded peg were subject to misalignment caused by environmental factors, such as wind and rain, or incidental contact. Such misalignment often renders the animal deterrent ineffective as it is no longer oriented to “watch” the protected area. Similarly, variations in the flora and the terrain surrounding the area to be protected affect the range at which the animal deterrent system operates, requiring the sensor unit to be mounted at various heights to compensate.

The patent literature also includes many patents to solve this problem.

U.S. Pat. No. 3,516,384 issued Jun. 23, 1970, to George A. Will, provided a warning system involving ultrasonic sounds which were inaudible to humans but may be perceived by animals and induce them to leave a highway or street.

U.S. Pat. No. 5,724,919 issued to Boyd et al. on Mar. 10, 1998 disclosed a hand-held varying-frequency ultrasonic trainer from which a positive or a negative reinforcement sound was generated by pressing the corresponding button. Depressing either button resulted in one of two audible stimuli which varies over a frequency range. One frequency range was selected to be soothing and the other is selected to be distressing to the animal. The device contained no sensing capabilities, relying upon input from the trainer before applying a reinforcement stimuli. Accordingly, the device was not suited for the continuous monitoring of a particular area as it required the constant attention of the person operating the hand-held unit to be effective.

U.S. Pat. No. 5,602,523, issued Oct. 30, 1995, to James Turchoie et al provided an repelling system, especially for deer which generated a square wave signal output in the ultrasonic frequency range, and which had a piezo-electric driver utilizing a horn type device that produced harmonic distortion so that at any given time the fundamental frequency and harmonic distortion is present in the audio output, and the system is capable of frequency switching to at least 10 different frequencies. It also disclosed a system consisting of a vehicle mounted warning system that emitted a high-pitched sound from the front of the vehicle.

U.S. Pat. No. 5,939,987, patented Aug. 17, 1995, by Randall S. Crom, provided a warning system to motorists to notify them of the presence of deer or other large animals along a roadside, such that the motorists can slow down and drive cautiously to avoid an accident with the deer. The system included a plurality of posts installed along the roadside, with each post having a motion detector for sensing the presence of deer. Each motion detector was operatively connected to a light which was activated when a deer entered the sensing zone of the motion detector. The lights and motion detectors may be connected to a 120 volt power supply or to a battery which is coupled to a solar panel for recharging. The lights may be electrically connected in series such that all the lights were illuminated when one motion detector senses a deer. Each motion detector may also be connected to a sound generating device to deter the deer from the roadside. A light-sensitive photoelectric eye may also be provided such that the devices were functional only at night.

U.S. Pat. No. 5,969,593, issued Oct. 19, 1999, to George A. Will, provided a warning system in combination with a vehicle in which ultrasonic sound and ultraviolet was beamed in advance of the moving vehicle on a thoroughfare so that sound and light may be heard and seen by an animal ahead of the moving vehicle to induce the animal to leave the road before it is struck by the vehicle. The device used a combination of flashing infrared or ultraviolet light together with ultrasound, shotgun sounds and the like. Both the ultrasonic noise and the flashing black light would be heard and seen by animals but not by humans.

U.S. Pat. No. 6,016,100, issued Jan. 18, 2000, to Randal D. Boyd et al provided a animal deterrent system for deterring animal intrusion into a specified area using an oscillating ultrasonic tone. The system includes a weatherproof housing containing an infrared detector for detecting the presence of an animal. To identify relevant intrusions, a count of the number of detections is maintained. After the count reaches predetermined number of infrared signals within a predetermined amount of time, an oscillating ultrasonic deterrent signal is generated to distress the animal and deter intrusion into the protected area. A deterrent timer activates the ultrasonic deterrent for a predetermined amount of time. A mounting stake for deploying the system in remote outdoor locations includes an anti-rotation mechanism, to prevent misalignment as a result of incidental contact.

U.S. Pat. No. 6,252,496 patented Jun. 26, 2001 by Otto V. Jackson, provided an animal warning alarm device that included a housing having a hollow tube projecting forwardly therefrom and an electronic sonic generator attached to the housing for providing a sonic wave that was channelled out through the forward open end of the tube which was angled downwardly in a forward direction, preferably at an angle of approximately 45° to the road surface beneath the vehicle. The sonic wave that was emitted from the tube was reflected off the road surface and produced a virtual sonic echo effect in front of the moving vehicle.

### SUMMARY OF THE INVENTION

(a) Aims of the Invention

None of the patents noted above suggested detecting the approach of a vehicle, but, instead, relied on detection of the animal, to trigger the deterrent signal.

Accordingly, a primary objective of the present invention is the provision of a method and system for warning deer and other large animals near a road of the existence of traffic on the road.

(b) Statement of Invention

The present invention provides a wildlife warning system that alerts wildlife at an animal crossing that a vehicle is approaching. The approaching automobile triggers a sensor in advance of the crossing area. The sensor then sends a signal to remote units which are strategically placed along the crossing area of the highway. The remote units provide means to repel the wildlife by means of sounds, lights, and/or scent.

By a first broad embodiment of this invention, a wildlife warning system is provided comprising a vehicle sensor adjacent to a roadway to sense an approaching vehicle, and to provide a sensor signal upon sensing the approach. The system also includes a warning alarm which is remote from the roadway to generate a first wildlife warning signal. Finally, the system includes a transmitter which is remotely connected to the vehicle sensor for transmitting a signal to the warning device, which receives the sensed signal and then sends the first warning alarm to the wildlife.

A second broad embodiment of this invention provides a method for warning wildlife to avoid a travelled roadway which comprises detecting approaching vehicular traffic on the roadway, and providing a warning alarm signal which is generated by a remote fixed warning signal generator to the wildlife upon detecting the approaching vehicular traffic.

(c) Other Features of the Invention

By a first feature of this first broad embodiment of this invention, the fixed warning alarm element transmits a first wildlife warning alarm signal, and also transmits a trigger to a second fixed warning alarm element for sending a second wildlife warning signal to the wildlife in a chain reaction manner.

By a second feature of this first broad embodiment of this invention, a master controller is also provided which is connected to a vehicle sensor to transmit RF signals to control one or more warning alarms in a pre-programmed manner.

By a third feature of this first broad embodiment of this invention, and/or the above features thereof, the vehicle sensor is an acoustic sensor. By a first feature thereof the acoustic sensor is microphone. By a second feature thereof, the acoustic sensor comprises: a first acousto-electric transducer for receiving a first acoustic signal which is radiated form the approaching vehicle and for converting the first acoustic signal into a first electric signal that represents the first acoustic signal, a second acousto-electric transducer for receiving a second acoustic signal which is radiated from the approaching vehicle and for converting the second acoustic signal into a second electric signal that represents the second acoustic signal, spatial discrimination circuitry for creating a third electric signal which is based on the first electric signal and on the second eclectic signal, that substantially represents the acoustic energy emanating from the predetermined zone, frequency discrimination circuitry for creating a fourth signal which is based on the third signal, and interface circuitry for creating an output signal which is based on the fourth signal such that the output signal is asserted when the approaching vehicle is within a predetermined zone and whereby the output signal is retracted when the vehicle is not within the predetermined zone.

By a fourth feature of this first broad embodiment of this invention, and/or the above features thereof, the vehicle sensor comprises an in-road sensor.

By a fifth feature of this first broad embodiment of this invention, and/or the above features thereof, the vehicle sensor comprises a DYNAX™ sensor.

By a sixth feature of this first broad embodiment of this invention, and/or the above features thereof, the vehicle sensor comprises an in-road sensor.

By a seventh feature of this first broad embodiment of this invention, and/or the above features thereof, the vehicle sensor comprises an on-road sensor.

By a eighth feature of this first broad embodiment of this invention, and/or the above features thereof, the vehicle sensor comprises an infrared sensor.

By a ninth feature of this first broad embodiment of this invention, and/or the above features thereof, the vehicle sensor comprises an optical sensor.

By a tenth feature of this first broad embodiment of this invention, and/or the above features thereof, the vehicle sensor comprises an ultrasonic vehicle detector.

By an eleventh feature of this first broad embodiment of this invention, and/or the above features thereof, the vehicle sensor comprises an active radar.

By a twelfth feature of this first broad embodiment of this invention, and/or the above features thereof, the vehicle sensor comprises a visible light sensor.

By a thirteenth feature of this first broad embodiment of this invention, and/or the above features thereof, the vehicle sensor comprises an ultraviolet light sensor.

By a fourteenth feature of this first broad embodiment of this invention, and/or the above variants thereof, the warning alarm comprises visible and/or infrared flashing or steady lights.

By a fifteenth feature of this first broad embodiment of this invention, and/or the above features thereof, the warning alarm comprises an audible warning sound.

By a sixteenth feature of this first broad embodiment of this invention, and/or the above features thereof, the warning alarm comprises a repulsive scent

By a seventeenth feature of this first broad embodiment of this invention, and/or the above features thereof, the warning alarm comprises an audible warning sound with a fixed frequency transmitter.

By an eighteenth feature of this first broad embodiment of this invention, and/or the above features thereof, the warning alarm comprises an audible warning sound with a variable frequency transmitter.

By a nineteenth feature of this first broad embodiment of this invention, and/or the above features thereof, the warning alarm comprises an ultrasonic warning sound with a fixed frequency transmitter.

By a twentieth feature of this first broad embodiment of this invention, and/or the above features thereof, the warning alarm comprises an ultrasonic warning sound with a variable frequency transmitter.

By a twenty-first feature of this first broad embodiment of this invention, and/or the above features thereof, the warning alarm is configured to generate a plurality of playing sequences so that the wildlife are less likely to become desensitized to the warning alarm.

By a twenty-second feature of this first broad embodiment of this invention, and/or the above features thereof, the wildlife warning system is in modular, expandible form.

By a twenty-third feature of this first broad embodiment of this invention, and/or the above features thereof, the wildlife warning system is provided by AC, DC or solar power. By a first variation thereof, the wildlife warning system incorporates a power saver mechanism therein.

By a twenty-fourth feature of this first broad embodiment of this invention, and/or the above features thereof, the wildlife warning system is a portable installation.

By a twenty-fifth feature of this first broad embodiment of this invention, and/or the above features thereof, the wildlife warning system is a permanently-installed installation.

By a twenty-sixth feature of this first broad embodiment of this invention, and/or the above features thereof, the wildlife warning system is installed on a two lane roadway with one lane of traffic in each direction, and includes, for each lane of traffic, a fixed sensor positioned to detect vehicles, a fixed detector and transmitter, and a fixed remote receiver and warning device which is disposed at a location which is remote from each shoulder of the roadway.

By a twenty-seventh feature of this first broad embodiment of this invention, and/or the above features thereof, the wildlife warning system is installed on a multiple lane roadway, with at least two lanes of traffic in each direction, and includes, for each lane of traffic, a fixed sensor positioned to detect vehicles, a fixed detector and transmitter, and a receiver and warning device which is disposed at a location which is remote from each shoulder of the roadway.

By a first feature of this second broad method embodiment of this invention, the method providing the warning alarm comprises chain triggering a plurality of warning alarms.

By a second feature of this second broad method embodiment of this invention, and/or the above features thereof, the method of providing the warning alarm comprises controlling a plurality of warning alarms in a pre-programmed manner.

(d) Generalized Description of the Invention

Accordingly, the following elements are required for the operation of the wildlife warning system: a vehicle sensor for sensing a vehicle, and a plurality of remote fixed warning units enabled by the vehicle sensor to provide a warning signal.

The wildlife warning system alerts wildlife at an animal crossing area that a vehicle is approaching. The approaching automobile triggers a fixed vehicle sensor in advance of the crossing area and the sensor then sends a signal to fixed remote units strategically placed along the crossing area of the highway. The remote units contain the necessary equipment (lights, sound, or scent) to frighten wildlife away from the road.

The wildlife warning system can be expanded with additional remote units to handle any length of highway section.

### BRIEF DESCRIPTION OF THE FIGURES

In the accompanying drawings,

FIG. 1A is a schematic top plan view of the general layout of the wildlife warning system of a general embodiment of an aspect of this invention;

FIG. 1B is a schematic top plan view of the layout of the wildlife warning system of a first specific embodiment of an aspect of this invention;

FIG. 1C is a schematic top plan view of the layout of the wildlife warning system of a second specific embodiment of an aspect of this invention;

FIG. 2 is a logic operation flow chart depicting the logic operation of another embodiment of an aspect of the system of this invention; and

FIG. 3 is a warning alarm flow chart depicting the operation of yet another embodiment of an aspect of the system of the invention.

### DESCRIPTION OF PREFERRED EMBODIMENTS

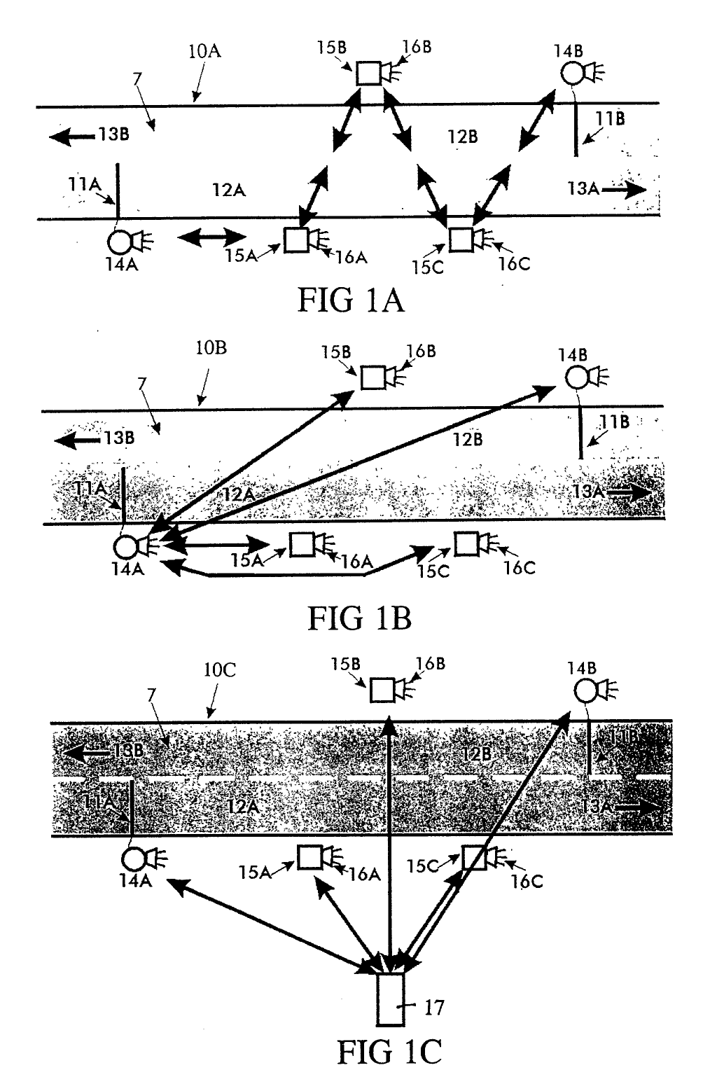

(a) Description of FIG. 1A

As seen in FIG. 1A, the system 10 includes a sensor 11A, 11B which is disposed across a respective lane 12A, 12B in each traffic flow direction, indicated by arrows 13A, 13B of a roadway 17. The vehicle sensor can be any conventional sensor.

For example it may be the so-called SMART SONIC™ sensor. The SMART SONIC™ sensor may be described as including a first acoustic-electric transducer for receiving a first acoustic signal which is radiated from a motor vehicle and for converting the first acoustic signal into a first electric signal that represents the first acoustic signal. The SMART SONIC™ also includes a second acoustic-electric transducer for receiving a second acoustic signal which is radiated from the motor vehicle and for converting the second acoustic signal into a second electric signal that represents the second acoustic signal. The SMART SONIC™ further includes spatial discrimination circuitry for creating a third electric signal which is based both on the first electric signal and on the second electric signal, that substantially represents the acoustic energy emanating from the zone surrounding the sensor. The SMART SONIC™ still further includes frequency discrimination circuitry for creating a fourth signal which is based on the third signal. Finally, the SMART SONIC™ includes interface circuitry for creating an output signal which is based on the fourth signal, such that the output signal is asserted when the motor vehicle is within the area surrounding the signal, and such that the output signal is retracted when the motor vehicle is not within the area surrounding the sensor.

The vehicle sensor can be a flexible carrier comprising an elongated flat elastomeric member having an elongated pressure sensor in a groove in one of its surfaces, as disclosed in U.S. Pat. No. 5,463,385 issued Oct. 31, 1995 to Tyburski.

The vehicle sensor can be a coaxial piezoelectric cable having a conducting core, a conducive polymer surrounding the core, a conductive sheath therearound and an electrically non-conductive gasket around the coaxial cable, as taught in U.S. Pat. No. 5,477,217 issued Dec. 19, 1995 to Bergan.

The vehicle sensor can be a flanged tube sensor with piezoelectric crystal plates, as taught in U.S. Pat. No. 5,461,924 patented Oct. 31, 1995 by Calderara et al.

The vehicle sensor can be the so-called DYNAX™ sensor, which is a force sensing variable resistor which is embedded in a resilient, rubber-like strip that is moulded around the resistor within an elongated sheet metal channel, as disclosed in U.S. Pat. No. 4,799,381, patented Jan. 24, 1989 by Tromp.

The vehicle sensor can be pressure-sensitive, light-conducting cables, as taught in U.S. Pat. No. 5,020,236, patented Jun. 4, 1991 by Kauer et al.

The vehicle sensor can be an infrared sensor system, as disclosed in U.S. Pat. No. 5,416,711, patented May 16, 1995 by Gron et al.

The vehicle sensors 11A, 11B are connected to detector and transmitters 14A, 14B. Such detector and transmitter preferably are custom built to cooperate with the vehicle sensors which are selected from among those described above, and the warning signallers which are selected from among those described above. Conventional such detectors and transmitters, which are well known to those skilled in the art, may alternatively be used.

The system 10A includes remote warning devices 15A, 15B, 15C. Conventional warning devices which may be used include one or more of flashing lights, audible sounds, ultra high frequency sounds or repellant scents, or any of the various warning signallers described above. As shown, these remote warning devices 15A, 15B, 15C include flashing lights 16A, 16B, 16C, respectively. The remote warning devices may include commercially available components (i.e., batteries, solar cells, transmitter/receiver, etc. The remotes are built and integrated using various commercial or custom built components. Examples of commercially-available such warning devices include the following:

The SUPER YARD GARD™ of Weitech Inc.: This device emits powerful, low ultrasonic noises. The sound moves around from one speaker to the next creating a wall of low ultrasonic sounds.

Barricide Warning Lights: These include flashing barricade lights, high intensity steady burn barricade lights and steady burn barricade lights.

ConeLite™ of Stinson: This is a bright LED flashing warning light.

TRUCK-LITE LED SELECT™: These are clearance and marker lighting.

STAR STROBE™: These have intensities of 4 TO 10 Joules, and are strobe warning lights in various lens colour of amber, red, blue, green, magenta and clear.

DEERWHISTLE™: This is a whistle which generates whistle sounds of less than 18,000 hertz and an ideal range of 110 yards.

A standard horn.

In the interconnection of the various components of the general embodiment of FIG. 1A sensor 11A, 11B are connected to detector and transmitter 14A, 14B, respectively. Remote warning device 15A is remotely connected (as by RF signals) between transmitter 14A and remotely connected (as by RF signals) between remote warning device 15B. Remote warning device 15B is also remotely connected (as by RF signals) between remote warning device 15C. Remote warning device 16C is also remotely connected, (as by RF signals) between detector and transmitter 14B.

Thus, this general embodiment of the invention provides a wildlife warning system which includes a vehicle sensor which is adjacent to a roadway to sense an approaching vehicle, and to provide a sensed signal upon sensing the approach of the approach of that vehicle. A fixed warning alarm element is remote from the roadway and is configured to generate a first wildlife warning alarm signal. A transmitter is remotely connected to the vehicle sensor for transmitting a signal to the warning alarm element. The warning alarm element thus receives the sensed signal and sends a first wildlife warning alarm signal to the wildlife.

(b) Description of FIG. 1B and FIG. 1C

In the following description of FIG. 1B and FIG. 1C, reference numbers therein which correspond to similar reference numbers in FIG. 1A denote identical elements.

As seen in FIG. 11B, the system 10B includes a sensor 11A, 11B which is disposed across a respective lane 12A, 12B in each traffic flow direction, indicated by arrows 13A, 13B of a roadway 17. The vehicle sensors 11A, 11B are connected to detector and transmitters 14A, 14B. The system 10B includes remote warning devices 15A, 15B, 15C. These remote warning devices include flashing lights 16A, 16B, 16C, respectively.

As described in detail with respect to FIG. 1A, the vehicle sensor can be any conventional sensor; the detector and transmitter preferably are custom built to cooperate with the above-described vehicle sensors; the warning signallers are selected from among those described above; the warning devices are selected from among those described above; and the remote warning devices may be built and integrated as described above.

In the interconnection of the various components of the specific embodiment shown in FIG. 1B, sensor 11A is connected to detector and transmitter 14A, and sensor 11B is connected to detector and transmitter 14B. Detector and transmitter 14A is the dominant component. It is remotely connected (as by RF signals) between remote warning device 15A; between remote warning device 15B; and between remote warning device 15C.

Thus, in this first specific embodiment, the fixed warning alarm element transmits a first wildlife warning alarm signal, and also transmits a trigger to a second fixed warning alarm element. This second fixed warning element then sends a second wildlife warning signal to the wildlife in a chain reaction manner.

As seen in FIG. 1C, the system 10C includes a sensor 11A, 11B which is disposed across a respective lane 12A, 12B in each traffic flow direction, indicated by arrows 13A, 13B of a roadway 17. The vehicle sensors 11A, 11B are connected to detector and transmitters 14A, 14B. The system 10B includes remote warning devices 15A, 15B, 15C. These remote warning devices include flashing lights 16A, 16B, 16C, respectively.

As described in detail with respect to FIG. 1A, the vehicle sensor can be any conventional sensor; the detector and transmitter preferably are custom built to cooperate with the above-described vehicle sensors; the warning signallers are selected from among those described above; the warning devices are selected from among those described above; and the remote warning devices may be built and integrated as described above.

In the interconnection of the various components of the specific embodiment shown in FIG. 1C, a master controller 17 is provided. Sensor 11A is connected to detector and transmitter 14A which is remotely connected (as by RF signals) between master controller 17. Sensor 11B is connected to detector and transmitter 14B, which is also remotely connected (as by RF signals) to master controller 17. Master controller 17 is then connected (as by RF signals) to warning device 15A; to warning device 15B; and to warning device 15C.

Thus, in this second specified embodiment, a master controller is connected to the vehicle sensor to transmit RF signals to control the fixed warning alarm element signallers in a pre-programmed manner.

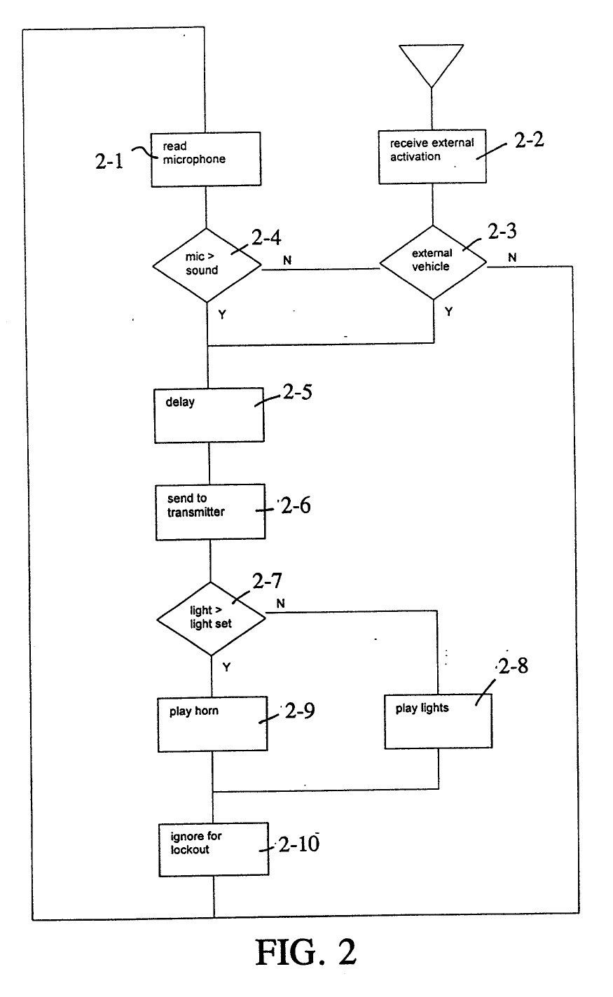

(c) Description of FIG. 2

The logic operation of one embodiment of the wildlife warning system of an aspect of this invention is depicted schematically in FIG. 2.

FIG. 2 shows two alternative starting points. The starting point on the logic operation flow chart will vary depending on the type of controller box. The detector box is one which listens for oncoming vehicles, then the flow chart begins with the READ MICROPHONE function, BLOCK 2-1.

If the detector is one of the receiver/transmitter boxes that receive signals by Radio Frequency (RF), and then the signal is passed on to the next box in line; the flow chart begins at the RECEIVE EXTERNAL ACTIVATION function, BLOCK 2-2.

As will be clear from FIG. 2, although the starting point for the two boxes, namely, BLOCK 2-1 and BLOCK 2-2 is different, both boxes will follow the same steps once the initial vehicle detection is completed.

The detector box BLOCK 2-1 or BLOCK 2-2, as its name implies, detects the oncoming vehicles, and so its system is continually reading the microphone sensor. If the microphone noise level is greater than the pre-set threshold MIC>SOUND, BLOCK 2-4, then the system acknowledges that there is an oncoming vehicle and continues onto the delay function, BLOCK 2-5.

If the microphone noise level is not greater than the pre-set threshold (MIC<SOUND) BLOCK 2-4, the system simply returns to the READ MICROPHONE function, BLOCK 2-1.

When the receiver/transmitter box receives a RF signal from a box up ahead RECEIVE EXTERNAL ACTIVATION, BLOCK 2-2, the system acknowledges that there is an oncoming vehicle EXTERNAL VEHICLE, BLOCK 2-3, and continues onto the DELAY function, BLOCK 2-5.

The DELAY function, BLOCK 2-5, is for delaying activation of the horn (or other warning signal) once a detection has been made. This is to allow the notification to proceed down a chain in a delayed fashion. Once the system has been delayed, it then sends the RF signal to the transmitter, SEND TO THE TRANSMITTER, BLOCK 2-6.

Next the system determines whether the warning device, e.g., the light, or the horn, etc., should be activated. If the light level is less than the pre-set light threshold LIGHT<LIGHT SET, BLOCK 2-7, the lights go off at PLAY LIGHTS, BLOCK 2-8. If the light level is greater than the pre-set light threshold LIGHT<LIGHTSET, BLOCK 27, the horn is played at PLAY HORN, BLOCK 2-9.

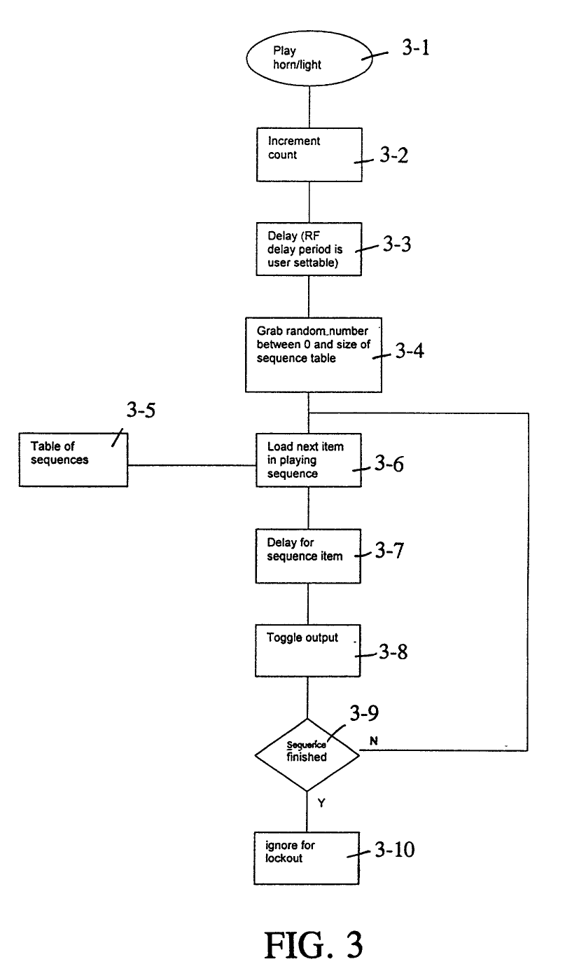

(d) Description of FIG. 3

The logic operation for the warning devices, e.g., the light and the horn will be described in detail later with reference to FIG. 3.

Once the horn/light (or other warning signal) is finished playing, the system goes into lockout mode IGNORE FOR LOCKOUT, BLOCK 2-10 and shuts itself down for a set period of time. The lockout mode ensures that the system does not run continuously when traffic levels are high. The system then returns to the starting function, either READ MICROPHONE BLOCK 2-1, or RECEIVE EXTERNAL ACTIVATION, BLOCK 2-2 depending on the type of box selected to initiate starting of the system.

FIG. 3 shows a warning alarm flow chart, for the embodiments where the warning alarm is either a horn or a light or any other suitable warning signal.

As seen in FIG. 3 the starting point is the play horn (or play lights or other warning signal) function. PLAY HORN/LIGHT, BLOCK 3-1.

As soon as the horn/light begins to play, the system starts an INCREMENT COUNT, BLOCK 3-2 which simply keeps track of the number of times the system has detected a vehicle. Once the increment count goes up, the RF signal is put into a DELAY mode, BLOCK 3-8. The RF delay period is user settable.

This delay time is simply the pre-set time period in which the control box that is currently being activated waits until it sends the signal to the next box in line. This time period ensures that the next box down the line will emit its wildlife deterring warning just before the vehicle passes that section of roadway. The distance between the WWS boxes and the speed that the vehicles are travelling will control the delay period. If the boxes are farther apart or if the vehicle is travelling at a slower speed, the delay period will be longer. If the boxes are closer together or if the vehicles are travelling at a faster speed, the delay time will be shorter.

Next, the system moves to the GRAB RANDOM NUMBER FUNCTION, BLOCK 3-4. The random number is an integer between zero and the size of the TABLE OF SEQUENCES, BLOCK 3-5. At this point the system simply grabs (or chooses) the next play sequence determined by a given number in the SEQUENCE ARRAY in the TABLE OF SEQUENCES, BLOCK 3-5. Once the system has chosen the new number (item) it loads this number (item) into the playing sequence. LOAD NEXT ITEM IN PLAYING SEQUENCE, BLOCK 3-6. By having many different playing sequences, wildlife will not hear/see the same noise/light all the time and so will be less likely to become desensitised to the warning device.

The RF transmission will always pass the signal to the next controller before the detected vehicle arrives. A DELAY FOR SEQUENCE ITEM, BLOCK 3-7, function allows a user settable delay in the warning activation. A controller (not seen) near the end of the chain can delay the warning device activation until the vehicle is closer to the area being protected. This allows more flexibility for reacting to different traffic speeds at different locations.

The wildlife warning controller has the capability of having additional animal warning devices. A TOGGLE OUTPUT, BLOCK 3-8 command activates the output channels on the controller board. If an external device is wired to the controller board, it will be activated during the toggle output function. If there is no external device added, the channel will still be activated.

Now the systems moves to the SEQUENCE FINISHED BLOCK 3-9 function. Depending on whether the system sequence is finished or nor the system will return back to the LOAD NEXT ITEM IN PLAYING SEQUENCE, BLOCK 3-6 function or continue on to the IGNORE FOR LOCKOUT, BLOCK 3-10 function.

### CONCLUSION

Thus, it is seen that the wildlife warning system of embodiments of this invention comprises a vehicle sensor for sensing a vehicle, and a plurality of fixed remote warning units which are placed along a roadside. The fixed warning units are triggered by detection of an approaching vehicle to produce a warning signal to the animal.

From the foregoing description, one skilled in the art can easily ascertain the essential characteristics of this invention, and without departing from the spirit and scope thereof, can make various changes and modifications of the invention to adapt it to various usages and conditions. Consequently, such changes and modifications are properly, equitably, and “intended” to be, within the full range of equivalence of the following claims.

1. A wildlife warning system comprising:
a) at least one vehicle sensor adjacent to a roadway to sense an approaching vehicle, and to provide a sensed signal upon sensing the approach of said vehicle approach;
b) at least one fixed warning alarm element which is remote from said roadway and which is configured to generate a first wildlife warning alarm signal; and and
c) at least one transmitter which is remotely connected to said at least one vehicle sensor for transmitting a signal to said at least one warning alarm element which receives said sensed signal and which sends said first wildlife warning alarm signal to said wildlife.

2. The wildlife warning system of claim 1, wherein said at least one fixed warning alarm element transmits a first said wildlife warning alarm signal, and which also transmits a trigger to a second fixed warning alarm element for sending a second wildlife warning signal to said wildlife in a chain reaction manner.

3. The wildlife warning system of claim 1, including a master controller which is connected to said vehicle sensor to transmit RF signals to control said fixed warning alarm element signaller in a pre-programmed manner.

4. The wildlife warning system of claim 1, wherein said vehicle sensor is an acoustic sensor.

5. The wildlife warning system of claim 4, wherein said acoustic sensor comprises: a first acousto-electric transducer for receiving a first acoustic signal which is radiated form the approaching vehicle and for converting the first acoustic signal into a first electric signal that represents the first acoustic signal; a second acousto-electric transducer for receiving a second acoustic signal which is radiated from the approaching vehicle and for converting the second acoustic signal into a second electric signal that represents the second acoustic signal; spatial discrimination circuitry for creating a third electric signal which is based on said first electric signal and on said second eclectic signal, that substantially represents the acoustic energy emanating from said predetermined zone; frequency discrimination circuitry for creating a fourth signal which is based on said third signal; and interface circuitry for creating an output signal which is based on said fourth signal such that said output signal is asserted when said approaching vehicle is within a predetermined zone and whereby said output signal is retracted when said vehicle is not within said predetermined zone.

6. The wildlife warning system of claim 1, wherein said vehicle sensor comprises an inroad sensor.

7. The wildlife warning system of claim 1, wherein said vehicle sensor comprises an on-road sensor.

8. The wildlife warning system of claim 6, wherein said vehicle sensor is a piezoelectric cable.

9. The wildlife warning system of claim 1, wherein said vehicle sensor comprises a DYNAX™ sensor.

10. The wild life warning system of claim 1, wherein said vehicle sensor comprises an infrared sensor.

11. The wildlife warning system of claim 1, wherein said vehicle sensor comprises an optical sensor.

12. The wildlife warning system of claim 1, wherein said vehicle sensor comprises an ultrasonic vehicle detector.

13. The wildlife warning system of claim 1, wherein said vehicle sensor comprises an active radar.

14. The wildlife warning system of claim 1, wherein said vehicle sensor comprises a visible light sensor.

15. The wildlife warning system of claim 1, wherein said vehicle sensor comprises an ultraviolet light sensor.

16. The wildlife warning system of claim 1, wherein said vehicle sensor comprises an acoustic sensor.

17. The wildlife warning system of claim 1, wherein said vehicle sensor comprises a microphone.

18. The wildlife warning system of claim 1, wherein said warning alarm comprises flashing lights.

19. The wildlife warning system of claim 1, wherein said warning alarm comprises an audible warning sound.

20. The wildlife warning system of claim 1, wherein said warning alarm comprises an ultrasonic warning sound.

21. The wildlife warning system of claim 1, wherein said warning alarm comprises a repulsive scent

22. The wildlife warning system of claim 1, wherein said warning alarm comprises an audible warning sound with a fixed frequency transmitter.

23. The wildlife warning system of claim 1, wherein said warning alarm comprises an audible warning sound with a variable frequency transmitter.

24. The wildlife warning system of claim 1, wherein said warning alarm comprises an ultrasonic warning sound with a fixed frequency transmitter.

25. The wildlife warning system of claim 1, wherein said warning alarm comprises an ultrasonic warning sound with a variable frequency transmitter.

26. The wildlife warning system of claim 1, wherein said warning alarm is configured to generate a plurality of playing sequences so that said wildlife are less likely to become desensitized to said warning alarm.

27. The wildlife warning system of claim 1, which is in modular, expandible form.

28. The wildlife warning system of claim 1, which is provided by AC, DC or solar power.

29. The wildlife warning system of claim 28, which incorporates a power saver mechanism therein.

30. The wildlife warning system of claim 1, which is a portable installation.

31. The wildlife warning system of claim 1, which is a permanently-installed installation.

32. The wildlife warning system of claim 1, which is installed on a two lane roadway with one lane of traffic in each direction, and including, for each lane of traffic, a sensor positioned to detect vehicles, a detector and transmitter, and a remote receiver and warning device which is disposed at a location which is remote from each shoulder of said roadway.

33. The wildlife warning system of claim 1, which is installed on a multiple lane roadway, with at least two lanes of traffic in each direction, and including, for each lane of traffic a sensor which is positioned to detect vehicles, a detector and transmitter, and a remote receiver and warning device which is disposed at a remote location from each shoulder of said roadway.

34. A method for warning wildlife to avoid a travelled roadway which comprises
(a) detecting approaching vehicular traffic on said roadway; and
(b) providing a warning alarm signal which is generated by a remote fixed warning signal generator to said wildlife upon detecting said approaching vehicular traffic.

35. The method of claim 34, wherein the providing of said warning alarm comprises triggering a plurality of warning alarm signals in a chain manner.

36. The method of claim 34, wherein the providing of said warning alarm comprises controlling a plurality of warning alarm signals in a pre-programmed manner.
